(19) United States
(12) Patent Application Publication
(10) Pub. No.: US 2026/0230839 A1
(43) Pub. Date: Aug. 6, 2026

(54) FIRST NODE, SECOND NODE AND METHODS PERFORMED THEREBY, FOR PLANNING RADIO COVERAGE IN A SPACE

(71) Applicant: Telefonaktiebolaget LM Ericsson (publ), Stockholm (SE)

(72) Inventors: Jyotirmoy BANERJEE, Bangalore (IN); Ram KUMAR SHARMA, Bangalore (IN); Hamender SINGH, Bangalore (IN); Sunil Kumar VUPPALA, Bangalore (IN); Kulasekaran P, Bangalore (IN); Sumit SOMAN, Bangalore (IN); Sendianto SUTIKNO, Stockholm (SE)

(21) Appl. No.: 19/147,191

(22) PCT Filed: Jan. 11, 2023
(86) PCT No.: PCT/IN2023/050027

§ 371 Date: Jul. 10, 2025

(51) Int. Cl. H04W 16/20; H04W 24/02

(52) U.S. Cl. CPC H04W 16/20; H04W 24/02

(57) ABSTRACT

A computer-implemented method performed by a first node for planning radio coverage in a space. The first node operates in a communications system. The first node determines, using machine learning and first radio coverage data from one or more first communications networks, an ML model. The ML model is to estimate a number of one or more radio antennas necessary to provide radio coverage to the space. The estimate is to be performed in the absence of a floor plan corresponding to the space. The first node also provides an indication of the determined ML model to a second node operating in the computer system.

### TECHNICAL FIELD

The present disclosure relates generally to a first node and methods performed thereby for planning radio coverage in a space. The present disclosure further relates generally to a second node and methods performed thereby, for planning radio coverage in the space. The present disclosure also relates generally to computer programs and computer-readable storage mediums, having stored thereon the computer programs to carry out these methods.

### BACKGROUND

Computer systems in a communications network or communications system may comprise one or more nodes. A node may comprise one or more processors which, together with computer program code may perform different functions and actions, a memory, a receiving port, and a sending port. A node may be, for example, a server. Nodes may perform their functions entirely on the cloud.

Computer systems may be comprised in a telecommunications network. The telecommunications network may cover a geographical area which may be divided into cell areas, each cell area being served by a type of node, a network node in the Radio Access Network (RAN), radio network node or Transmission Point (TP), for example, an access node such as a Base Station (BS), e.g., a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g., Wide Area Base Stations, Medium Range Base Stations, Local Area Base Stations and Home Base Stations, based on transmission power and thereby also cell size. A cell may be understood to be the geographical area where radio coverage may be provided by the base station at a base station site. One base station, situated on the base station site, may serve one or several cells. Further, each base station may support one or several communication technologies. The telecommunications network may also comprise network nodes which may serve receiving nodes, such as user equipments, with serving beams.

In the course of operations of the telecommunications network, data may be collected on the performance of the telecommunications network, which may enable to monitor and manage the malfunctioning of any of its elements.

The advent of for example, the Internet of Things (IOT) has exponentially increased the amount of data to be monitored. The availability of large amounts of data, such as those collected for example, from IoT devices, may be understood to enable the possibility of analysing such data to make predictions on events, with a high predictive power. To make predictions on events may be understood to refer to building mathematical models that may fit those data, which mathematical models may then be used to make predictions for such events. Within this context, machine learning models may be used to analyze the data collected, and enable an improved management of the operation of the telecommunications network.

### Machine Learning

Machine learning (ML) may be understood as the study of computer algorithms that may improve automatically through experience. It is seen as a part of Artificial Intelligence (AI). ML algorithms may build a model based on sample data, known as “training data”, in order to make predictions or decisions without being explicitly programmed to do so. ML algorithms may be used in a wide variety of applications, such as email filtering and computer vision, where it may be difficult or unfeasible to develop conventional algorithms to perform the needed tasks.

There may be basically 3 types of ML Algorithms: Supervised Learning, Unsupervised Learning, and Reinforcement Learning (RL).

Supervised Learning algorithms may comprise a target/outcome variable, or dependent variable, which may have to be predicted from a given set of predictors, that is, independent variables. Using this set of variables, a function may be generated that may map inputs to desired outputs. The training process may continue until the model may achieve a desired level of accuracy on the training data. Once an ML model may have been trained, an inference process may begin, whereby new data may be run through the ML model to calculate an output. Examples of Supervised Learning may be Regression, Decision Tree, Random Forest, KNN, Logistic Regression etc.

In Unsupervised Learning algorithms, there may be no target or outcome variable to predict/estimate. It may be used for clustering a population into different groups, which may be widely used for segmenting customers in different groups for specific intervention. Examples of Unsupervised Learning may be K-means, mean-shift clustering, Density-Based Spatial Clustering of Applications with Noise (DBSCAN), Expectation-Maximization (EM) Clustering using Gaussian Mixture Models (GMM), Agglomerative Hierarchical Clustering, etc. . . . .

Cluster analysis or clustering may be understood as an ML technique which may comprise grouping a set of objects in such a way that objects in the same group, which may be called a cluster, may be understood to be more similar, in some sense, to each other than to those in other groups, that is, other clusters. It may be understood as a main task of exploratory data mining, and a common technique for statistical data analysis, used in many fields, including pattern recognition, image analysis, information retrieval, bioinformatics, data compression, computer graphics and ML.

Using an RL algorithm, a machine may be trained to make specific decisions. It may be understood to work as follows: the machine may be exposed to an environment where it may train itself continually using trial and error. This machine may learn from past experience and may try to capture the best possible knowledge to make accurate business decisions. An example of RL may be a Markov Decision Process (MDP). The training using RL may comprise generating an ML model. To train such an ML model, an agent, given a state of the environment, may take an action in this environment and receive a reward. The action may result in a new state of the environment. This process may be repeated in a loop. Over time, the agent may learn to take actions that may result in larger immediate and future rewards, meaning that it may be understood to be in the best interest of the agent not to take the action that may only lead to the highest reward in the next state, but the action that may cumulatively lead to the highest reward in the next state and in a future number of states.

The agent may comprise a neural network which may input the state and may produce an action. There may be several ML algorithms that may be used for training the network of the agent, e.g., policy-learning based, such as actor-critic approaches, or value-based learning, such as deep-q networks.

The standardization organization Third Generation Partnership Project (3GPP) is currently in the process of specifying a New Radio Interface called Next Generation Radio or New Radio (NR), as well as a Fifth Generation (5G) Packet Core Network, which may be referred to as 5G Core Network (5GC). The advantages of 5G NR may include higher bandwidth, more resources, low latency and network slicing. 5G may provide services to various applications, such as enhanced Mobile Broad Band (eMBB), machine to Machine type communication (mMTC), Ultra Reliable Low Latency Communication (URLLC), etc.

5G may be understood to bring in sizeable flexibility with technological advancements along with innovations of cloud and AI. This may be understood to bring a whole new set of opportunities in the enterprise segment.

For many enterprises, mobile cellular technology has already proven to bring great value to their digitalization process, which may include numerous use cases, such as autonomous robotics, enhanced video services, connected vehicles, remote operations, hazard, and maintenance sensors etc. This may be understood to not only enhance productivity in connected factories, but also make workplaces safer.

Enterprise Private Network may be understood as a solution built on 3GPP standards, designed to support the evolution of private mobile networks, used for various enterprise needs requiring high performance mobile connectivity.

Enterprise private networks may have specific requirements related to coverage, performance, security and reliability to solve the complexity of communications and achieve global business scalability; these industries may require robust connectivity in an open system, that is, a network not bound to just one vendor, to modernize the existing capabilities.

An enterprise network may have a localized core network, such as an Evolved Packet Core (EPC) or 5GC, and radio antennas, such as “dots”, which may be understood to support Long-Term Evolution (LTE)/5G, or micro radio, Indoor Radio Units (IRU) and baseband as major network components.

Depending on the actual site conditions, a mixture of radio equipment between radio antennas and micro radio product selection may be needed to achieve optimal results in terms of coverage and performance. RAN indoor planning may be understood to involve performing exhaustive site survey, picking up floor plan and using propagation model tools on top of such floor plans to have simulations of radio antennas, or micro radio, to check the resultant signal strength, which may be achieved by varying the number of such radio antennas to identify an optimal mix. An existing approach of indoor radio planning is described in U.S. Pat. Nos. 7,881,720 and 9,998,928. This approach uses a propagation model to generate a signal fingerprint. To estimate the number of radio antennas to be used for the planning, the users may need to manually select the location of the radio antennas and iteratively perform this activity to estimate the number of radio antennas. WO 2022033723 uses a method for optimizing the positioning of base stations to be deployed for optimised performance of a cellular network. The approach following in this case requires a floorplan and includes defining a target area and identifying a set S of base station deployment candidate sites within the target area, by executing a joint performance optimization routine that aims at jointly optimizing network throughput and positioning performance. The objective is to maximize the Signal-to-Noise-and-Interference-Ratio (SINR) association between a typical UE at a point t and candidate site j, respectively. Active candidate sites are obtained as a subset of a set S of base station deployment candidate sites. The obtained active candidate sites are determined as the sites at which base stations are to be deployed.

Existing methods for planning radio coverage of spaces within a communications network may be time consuming and result in inappropriate provision of QoS, as well as run into confidentiality issues which may further delay or complicate the planning process.

### SUMMARY

As part of the development of embodiments herein, one or more problems with the existing technology will first be identified and discussed.

Enterprises may be understood to be consumers of private networks. An enterprise may belong to a specific category e.g., manufacturing, mining, port etc. Based on category, each enterprise may vary with their coverage and Quality of service (QoS) requirements. Since an enterprise may be large in area, these requirements may also vary within specific areas inside a same enterprise. For example, an area where production may be performed with help of autonomous robots may have a stricter requirement on QoS e.g., latency and throughput, than 10 a normal office type area inside that enterprise. Hence, a planning exercise may need to consider such fine granular aspects.

Existing tools for planning of radio coverage within different spaces may use propagation models, such as Fast Ray Tracing COST231 on given floor plans to meet coverage targets. The mandatory requirement for all the currently existing tools is the availability of a floor plan. If there are no floor plans, these tools may not work. Since some network owners may want to protect the floor plan information of their networks from divulgation due to security and/or privacy concerns, floor plans access may sometimes be restricted or prohibited.

Another issue with existing tools is processing time. Since these tools use ray tracing, for large enterprises, based on propagation model, tracing is performed for each individual unit area, which results in higher processing time for generation of results.

Another limitation in existing tools is the lack of flexibility for coverage planning as per enterprise need for different type of area, such as manufacturing, warehouse, office etc. Current tools do not provide for demarcation of various zones inside a single enterprise, as per QoS and coverage needed for that zone. Existing methods may be understood to perform planning by considering an entire floor as a single homogenous floor, but not as a collection of multiple areas in a single floor. This may be understood to result in an inadequate planning of radio coverage for such spaces, with either overprovision of coverage and therefore wasted resources, or under provision, and hence underperforming networks.

It is therefore an object of embodiments herein to improve the planning of radio coverage in a space.

According to a first aspect of embodiments herein, the object is achieved by a computer-implemented method, performed by a first node. The method is for planning radio coverage in a space. The first node determines, using ML, and first radio coverage data from one or more first communications networks, an ML model. The ML model is to estimate a number of one or more radio antennas necessary to provide radio coverage to the space. The estimate is to be performed in the absence of a floor plan corresponding to the space. The first node then provides an indication of the determined ML model to a second node operating in the computer system.

According to a second aspect of embodiments herein, the object is achieved by a computer-implemented method, performed by the second node. The method is for planning radio coverage in the space. The second node operates in the computer system. The second node obtains, from the first node operating in the computer system, the indication of the determined ML model. The ML model is to estimate the number of the one or more radio antennas necessary to provide radio coverage to the space. The estimate is to be performed in the absence of the floor plan corresponding to the space. The second node then infers, in the absence of the floor plan corresponding to a target space, and using the determined ML model, the number of one or more radio antennas necessary to provide radio coverage to the target space. The second node finally outputs a second indication based on a result of the inferencing. The second indication indicates the inferenced number of the one or more radio antennas necessary to provide radio coverage to the target space

According to a third aspect of embodiments herein, the object is achieved by the first node. The first node may be understood to be for planning radio coverage in the space. The first node is configured to operate in the computer system. The first node is further configured to determine, using ML, and the first radio coverage data from the one or more first communications networks, the ML model. The ML model is to estimate the number of the one or more radio antennas necessary to provide radio coverage to the space. The estimate is configured to be performed in the absence of the floor plan corresponding to the space. The first node is also configured to provide the indication of the ML model configured to be determined to the second node configured to operate in the computer system.

According to a fourth aspect of embodiments herein, the object is achieved by the second node. The second node may be understood to be for planning radio coverage in the space. The second node is configured to operate in the computer system. The second node is configured to obtain, from the first node configured to operate in the computer system, the indication of the determined ML model. The ML model is configured to estimate the number of one or more radio antennas necessary to provide radio coverage to the space. The estimate is configured to be performed in the absence of the floor plan corresponding to the space. The second node is also configured to infer, in the absence of the floor plan corresponding to the target space, and using the determined ML model, the number of one or more radio antennas necessary to provide radio coverage to the target space. The second node is further configured to output the second indication based on the result of the inferencing. The second indication is configured to indicate the number configured to be inferenced of the one or more radio antennas necessary to provide radio coverage to the target space.

According to a fifth aspect of embodiments herein, the object is achieved by a computer program, comprising instructions which, when executed on at least one processing circuitry, cause the at least one processing circuitry to carry out the method performed by the first node.

According to a sixth aspect of embodiments herein, the object is achieved by a computer-readable storage medium, having stored thereon the computer program, comprising instructions which, when executed on at least one processing circuitry, cause the at least one processing circuitry to carry out the method performed by the first node.

According to a seventh aspect of embodiments herein, the object is achieved by a computer program, comprising instructions which, when executed on at least one processing circuitry, cause the at least one processing circuitry to carry out the method performed by the second node.

According to an eighth aspect of embodiments herein, the object is achieved by a computer-readable storage medium, having stored thereon the computer program, comprising instructions which, when executed on at least one processing circuitry, cause the at least one processing circuitry to carry out the method performed by the second node.

By determining the ML model to estimate the number of the one or more radio antennas necessary to provide radio coverage to the space, the first node may be enabled to plan the radio coverage in any space, accurately, rapidly, and without higher end hardware requirements. Advantageously, the planning may be understood to not require a floorplan of the space, or its simulation. Hence, the planning process may be enabled to be simplified and expedited, enabling any party wishing to obtain the planning, to do so effectively, without having to incur into privacy and/or security issues.

By providing the indication, the first node may then enable the second node to plan the radio coverage for the target space. This may be performed by either enabling the second node to perform inferencing of the number of one or more radio antennas necessary to provide radio coverage to the target space using the determined ML model, and/or by enabling the second node to implement the radio coverage in the target space with an inferenced number of one or more radio antennas. Either way, the providing of the indication may be understood to enable planning the radio coverage in the target space, accurately, rapidly, and without higher end hardware requirements. Advantageously, the planning may be understood to not require a floorplan of the space, or its simulation. Hence, the planning process may be enabled to be simplified and expedited, enabling any party wishing to obtain the planning, to do so effectively and accurately, without having to incur into privacy and/or security issues.

By obtaining the indication, the second node may be enabled to plan the radio coverage for the target space. This may be performed by either obtaining the first indication, thereby enabling the second node to perform the inferencing of the number of one or more radio antennas necessary to provide radio coverage to the target space, or by obtaining the second indication, and thereby enabling the second node to enable itself to implement the radio coverage in the target space with the inferenced number of number of one or more radio antennas and optionally, the indicated set of materials.

By inferencing the number of one or more radio antennas necessary to provide radio coverage to the target space, the second node may enable to plan, either itself, or a user of the second node, the radio coverage in the target space, accurately, rapidly, and without higher end hardware requirements. Advantageously, the planning may be understood to not require a floorplan of the target space, or its simulation. Hence, the planning process may be enabled to be simplified and expedited, enabling any party wishing to obtain the planning, to do so effectively, without having to incur into privacy and/or security issues.

By outputting the second indication, the second node may then enable to implement the radio coverage in the target space with the inferenced number of number of one or more radio antennas and optionally, the indicated set of materials.

The providing the second indication may be understood to enable planning the radio coverage in the target space, accurately, rapidly, and without higher end hardware requirements. Advantageously, the planning may be understood to not require a floorplan of the space, or its simulation. Hence, the planning process may be enabled to be simplified and expedited, enabling any party wishing to obtain the planning, to do so effectively and accurately, without having to incur into privacy and/or security issues.

### BRIEF DESCRIPTION OF THE DRAWINGS

Examples of embodiments herein are described in more detail with reference to the accompanying drawings, according to the following description.

FIG. 1 is a schematic diagram illustrating two non-limiting examples of a computer system, according to embodiments herein.

FIG. 2 is a flowchart depicting a method in a first node, according to embodiments herein.

FIG. 3 is a flowchart depicting a method in a second node, according to embodiments herein.

FIG. 4 is a schematic diagram depicting particular aspects of a non-limiting example of the method performed by the first node and/or the second node, according to embodiments herein.

FIG. 5 is a schematic diagram depicting particular aspects of another non-limiting example of the method performed by the first node, according to embodiments herein.

FIG. 6 is a schematic diagram depicting particular aspects of a further non-limiting example of the method performed by the first node, according to embodiments herein.

FIG. 7 is a schematic diagram depicting particular aspects of an additional non-limiting example of the method performed by the first node, according to embodiments herein.

FIG. 8 is a schematic block diagram illustrating an embodiment of a first node, according to embodiments herein.

FIG. 9 is a schematic block diagram illustrating an embodiment of a second node, according to embodiments herein.

### DETAILED DESCRIPTION

Certain aspects of the present disclosure and their embodiments address the challenges identified in the Background and Summary sections with the existing methods and provide solutions to the challenges discussed.

Embodiments herein may be understood to relate to a cognitive enterprise indoor planning.

Embodiments herein may be understood to enable to overcome the challenges mentioned in the Summary section by providing an AI based planning tool, which may be understood to enable to estimate a count of required radio antennas, based on input information, e.g., of floor size, without requiring actual floor plan.

Embodiments herein may be understood to combine a propagation model with a data driven approach to reduce the processing time for the generation of output. In order to enable to reduce the dependency on a floor plan being input, an AI model may be trained on existing deployed enterprise floorplans to learn features which may influence radio coverage, such as wall density, QoS zone area identification etc. Once these features and/or parameters may have been learned, a rate of radio antennas may be determined for one or more specific QoS zones of an industry vertical. The learning may be used for any new input of floor area, belonging to a same industry vertical, in order to determine the total radio antenna count, without requiring the provision of the floor plan as input. Subsequently, the count may be utilized to generate a Bill of material (BOM).

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

Several embodiments and examples are comprised herein. It should be noted that the embodiments and/or examples herein are not mutually exclusive. Components from one embodiment or example may be tacitly assumed to be present in another embodiment or example and it will be obvious to a person skilled in the art how those components may be used in the other exemplary embodiments and/or examples.

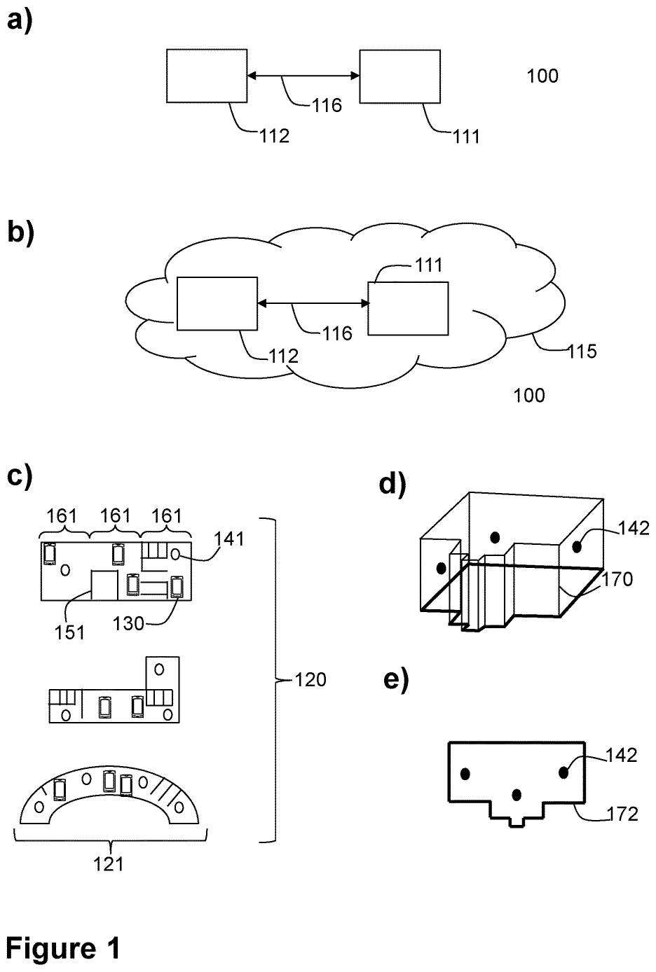

FIG. 1 depicts two non-limiting examples, in panels “a” and “b”, respectively, of a computer system 100, in which embodiments herein may be implemented. In some example implementations, such as that depicted in the non-limiting examples of FIG. 1, the computer system 100 may be a computer network. In other example implementations, which are not depicted in FIG. 1, the computer system 100 may be implemented in a telecommunications system, sometimes also referred to as a cellular radio system, cellular network or wireless communications system. In some examples, the telecommunications system may comprise network nodes which may serve receiving nodes, such as wireless devices, with serving beams.

In some examples, the telecommunications system may for example be a network such as 5G system, or Next Gen network. The telecommunications system may also, or alternatively, support other technologies, such as an LTE network, e.g. LTE Frequency Division Duplex (FDD), LTE Time Division Duplex (TDD), LTE Half-Duplex Frequency Division Duplex (HD-FDD), LTE operating in an unlicensed band. The telecommunications system may also support other technologies, such as Wideband Code Division Multiple Access (WCDMA), Universal Terrestrial Radio Access (UTRA) TDD, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

The computer system 100 comprises nodes, whereof a first node 111 and a second node 112 are depicted in FIG. 1. In some examples, which are not depicted in FIG. 1, the first node 111 and the same node 112 may be co-located or be the same node. The computer system 100 may comprise additional nodes.

Any of the first node 111 and the second node 112 may be understood, respectively, as a first computer system or server, and a second computer system or server. Any of the first node 111 and the second node 112 may be implemented as a standalone server in e.g., a host computer in the cloud 115, as depicted in the non-limiting example of FIG. 1b). In other examples, any of the first node 111 and the second node 112 may be a distributed node or distributed server, such as a virtual node in the cloud 135, and may perform some of its respective functions locally, e.g., by a client manager, and some of its functions in the cloud 115, by e.g., a server manager. In other examples, any of the first node 111 and the second node 112 may perform its functions entirely on the cloud 115, or partially, in collaboration or collocated with a radio network node. Yet in other examples, any of the first node 111 and the second node 112 may also be implemented as processing resources in a server farm. Any of the first node 111 and the second node 112 may be under the ownership or control of a service provider or may be operated by the service provider or on behalf of the service provider.

Any of the first node 111, and the second node 112 may be understood to have a capability to perform machine-implemented learning procedures, which may be also referred to as “machine learning” (ML).

In some embodiments, any of the first node 111 and the second node 112 may be a core network node, such as, e.g., a network data analytics function (NWDAF), a Service management and orchestration (SMO) node, a positioning node, a coordinating node, a Self-Optimizing/Organizing Network (SON) node, a Minimization of Drive Test (MDT) node, etc. . . . . In 5G, for example, any of the first node 111 and the second node 112 may be located in the Operations Support Systems (OSS).

In other examples not depicted in FIG. 1, any of the first node 111 and the second node 112 may be a radio network node. A radio network node may be, e.g., comprised in a Radio Access Network of the telecommunications system. That is, the radio network node may be a transmission point such as a radio base station, for example a gNB, an eNB, or any other network node with similar features capable of serving a wireless device, such as a user equipment or a machine type communication device, in the computer system 100. In typical examples, the radio network node may be a base station, such as a gNB or an eNB. In other examples, the radio network node may be a distributed node, such as a virtual node in the cloud 115, and may perform its functions entirely on the cloud 115, or partially, in collaboration with a radio network node.

The telecommunications system may cover a geographical area, which in some embodiments may be divided into cell areas, wherein each cell area may be served by a radio network node, although, one radio network node may serve one or several cells. In the example of FIG. 1, the cells are not depicted to simplify the figure. The network node may be of different classes, such as, e.g., macro eNodeB, home eNodeB or pico base station, based on transmission power and thereby also cell size. In some examples, the network node may serve receiving nodes with serving beams.

Any of the first node 111, the second node 112, and/or any of the nodes comprised in the computer system 100 may support one or several communication technologies, and its name may depend on the technology and terminology used. Any of the radio network nodes that may be comprised in the computer system 100 may be directly connected to one or more core networks.

A plurality of devices may be comprised in the telecommunication network. Any device comprised in the wireless computer system 100 may be a wireless communication device such as a 5G UE, or a UE, which may also be known as e.g., mobile terminal, wireless terminal and/or mobile station, a Customer Premises Equipment (CPE) a mobile telephone, cellular telephone, or laptop with wireless capability, just to mention some further examples. Any of the devices comprised in the telecommunications system may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, device equipped with a wireless interface, such as a printer or a file storage device, modem, or any other radio network unit capable of communicating over a radio link in a communications system. Any device comprised in the telecommunications system is enabled to communicate wirelessly in the telecommunications system. The communication may be performed e.g., via a RAN, and possibly the one or more core networks, which may be comprised within the wireless telecommunications system.

The first node 111 may be configured to communicate within the computer system 100 with second node 112 over a first link 116, e.g., a radio link, or a wired link.

The first link 116 may be a direct link or may be comprised of a plurality of individual links, wherein it may go via one or more computer systems or one or more core networks in the computer system 100, which are not depicted in FIG. 1, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 1.

Any of the first node 111 and the second node 112 may have access to, and have the capability to analyze, radio coverage data from one or more first communications networks 120, sometimes also referred to as a cellular radio systems, cellular networks or wireless communications systems. In some examples, any of the one or more first communications networks 120 may comprise network nodes which may serve receiving nodes, such as wireless devices, with serving beams.

In some examples, any of the one or more first communications networks 120 may for example be a network such as may for example be a network such as 5G system, or Next Gen network. Any of the one or more first communications networks 120 may also, or alternatively, support other technologies, such as an LTE network, e.g. LTE Frequency Division Duplex (FDD), LTE Time Division Duplex (TDD), LTE Half-Duplex Frequency Division Duplex (HD-FDD), LTE operating in an unlicensed band. Any of the one or more first communications networks 120 may also support other technologies, such as Wideband Code Division Multiple Access (WCDMA), Universal Terrestrial Radio Access (UTRA) TDD, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

Any of the one or more first communications networks 120 may provide radio coverage to a geographical area that may comprise one or more buildings. The one or more buildings may comprise one or more floor plans 121. This is schematically represented in the non-limiting example of panel c) in FIG. 1, wherein each of the one or more floor plans 121 has a respective shape.

A respective plurality of devices 130 may operate in the respective spaces defined by the one or more floor plans 121. Each of the devices in the a respective plurality of devices 130 may be a device as described above.

The one or more floor plans 121 comprise a respective distribution of a respective set of one or more first radio antennas 141. Each of the one or more first radio antennas 141 may be understood as a radio network node, as described above.

The one or more first communications networks 120 may respectively cover a geographical area, which in some embodiments may be divided into cell areas, wherein each cell area may be served by a first radio antenna 141, although, one first radio antenna 141 may serve one or several cells. In the example of FIG. 1, the cells are not depicted to simplify the figure. The one or more first radio antennas 141 may be of different classes, such as, e.g., macro eNodeB, home eNodeB or pico base station, based on transmission power and thereby also cell size. In some examples, the one or more first radio antennas 141 may serve receiving nodes with serving beams.

Any of the one or more first radio antennas 141 may support one or several communication technologies, and their name may depend on the technology and terminology used. Any of the one or more first radio antennas 141 that may be comprised in the one or more first communications networks 120 may be directly connected to one or more core networks.

Each of the one or more floor plans 121 comprises a respective distribution of obstacles 151. The obstacles 151 may be understood to be structural elements that may hinder the propagation of radio waves, such as, for example walls, pillars, columns, etc. . . . .

Each of the one or more floor plans 121 may comprise a respective set of one or more zones 161. Each zone of the one or more zones 161 may correspond to a respective density level of the obstacles 151, e.g., low, medium, high, etc. . . . .

Embodiments herein, as will be described in the next figures may aim at estimating a number of one or more radio antennas 142 which may be necessary to provide radio coverage to a space 170. The space 170 may be understood as a theoretical geographical volume, a non-limiting example of which is schematically represented in panel d) of FIG. 1. The space 170 may therefore adopt any forms or shapes. Any of the one or more radio antennas 142 may be understood to have a description similar to that provided for the one or more first radio antennas 141. However, while the one or more first radio antennas 141 may be understood to be real objects, the one or more radio antennas 142 may be understood to be predicted, or projected.

In some embodiments, input may be received to perform a particular inference in a target space 172, a non-limiting example of which is schematically represented in panel e) of FIG. 1. The target space 172 may be understood to be, in contrast to the space 170, a real world space 172, e.g., in a real world construction, for which the rough measurements of its floor plan may be usually provided to indicate its physical space delimitations. The goal may be to estimate the number of one or more radio antennas 142 that may be necessary to provide radio coverage to the target space 172.

Any of the devices in the respective plurality of devices 130 may be configured to communicate within the respective one or more first communications networks 120 with any of the antennas in the respective set of one or more first radio antennas 141 over a respective link, e.g., a radio link, or a wired link, which is not depicted in FIG. 1 to simplify the figure.

In general, the usage of “first”, “second”, “third”, “fourth”, “fifth”, “sixth” and/or “seventh” herein may be understood to be an arbitrary way to denote different elements or entities, and may be understood to not confer a cumulative or chronological character to the nouns they modify.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

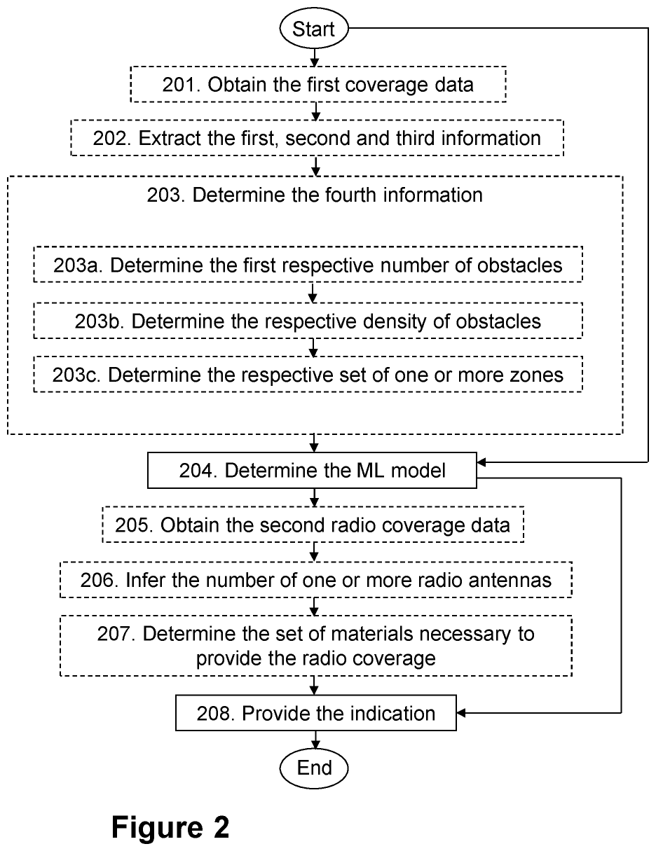

Embodiments of a computer-implemented method, performed by the first node 111, will now be described with reference to the flowchart depicted in FIG. 2. The method is for planning radio coverage in the space 170. The first node 111 operates in the computer system 100.

Several embodiments are comprised herein. In some embodiments all the actions may be performed. In some embodiments, some actions may be optional. In FIG. 2, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description.

### Action 201

In this Action 201, the first node 111 may obtain first radio coverage data. The first node 111 may obtain the first radio coverage data by retrieving it from e.g., a database or memory. In some non-typical examples, some of the data, e.g., performance data, may be obtained online. The first radio coverage data may comprise one or more images.

The first radio coverage data may be understood to be network design files.

The first radio coverage data may comprise the one or more floor plans 121. The one or more floor plans 121 may comprise the respective distribution of the respective set of one or more first radio antennas 141.

The first radio coverage data may also comprise a respective set of radio performance data collected from the respective plurality of devices 130 operating in respective spaces defined by the one or more floor plans 121.

The radio performance data may comprise, for example, Key performance indicators (KPI). Some example KPIs may be latency, throughput, Random Access Channel (RACH) success rate, Signal to Interference and Noise Ratio (SINR), Channel Quality Indicator (CQI), Modulation and Coding Scheme (MCS), pathloss, etc.

As described earlier, each of the one or more floor plans 121 may comprise a respective distribution of obstacles 151.

By obtaining the first radio coverage data in this Action 201, the first node 111 may then be enabled to use the obtained first radio coverage data to ultimately train an ML model that may enable to plan the provision of radio coverage to a space for which a floor plan may not be available. That is, to train an ML model that may then be independent of the existence of a floor plan in order to estimate how many radio antennas may be necessary to provide radio coverage to a space.

### Action 202

In this Action 202, the first node 111 may extract, from the obtained first radio coverage data, and per floor plan of the one or more floor plans 121, the following information. The first node 111 may extract first information indicating the respective distribution of the obstacles 151. The first information may comprise at least one of: a) a number of the obstacles 151 and b) a distribution of the obstacles 151. The distribution of the obstacles 151 may be understood to refer to the arrangement in the respective floor plan, of the one or more floor plans 121, of the obstacles 151, e.g., e.g., the disposition on the floor of the walls.

The first node 111 may also extract second information. The second information may indicate a respective location of the respective set of one or more first radio antennas 141. The first node 111 may further extract third information. The second information may indicate a respective contour of the one or more floor plans 121. Examples of the respective contours may be as depicted in panel c) of FIG. 1.

For example, in this Action 202, the first node 111 may extract the walls, location of respective set of one or more first radio antennas 141 and floor contour from the design files obtained in Action 201.

The extracting in this Action 202 may be based on image processing. Image processing modules may be built to extract the floor contour and the locations of the respective set of one or more first radio antennas 141 from the respective images. Image processing modules may also be built to extract walls from the floor plans.

By, in this Action 202, extracting the first information, second information and third information from the obtained first radio coverage data, per floor plan, the first node 111 may be enabled to then use the extracted information to, first determined the existence of difference zones within each floor, as will be described in the next Action 203, and then,
ultimately train an ML model that may enable to plan the provision of radio coverage to a space for which a floor plan may not be available. That is, to train an ML model that may then be independent of the existence of a floor plan in order to estimate how many radio antennas may be necessary to provide radio coverage to a space.

### Action 203

In this Action 203, the first node 111 may determine, per floor plan of the one or more floor plans 121, and based on the extracted first information, second information and third information, fourth information. The fourth information may indicate the respective set of one or more zones 161. That is, in this Action 203, the first node 111, using the information extracted in Action 202 may extract the various zones per floor map. Particularly, using image processing, the first node 111 may process the wall segmentation images to extract the wall region density. As stated earlier, each zone may correspond to a respective density level of the obstacles 151. Hence, for example, the first node 111, in this Action 203 may estimate multiple zones within a floor map using obstacle, e.g., wall region density.

The determining in this Action 203 may be understood as calculating, deriving, estimating or similar. The actions performed in order to extract multiple zones within a floor map using wall region density, may be as follows.

In some embodiments, the determining in this Action 203 of the fourth information may comprise determining 203a, for every pixel in one or more images comprised in the first radio coverage data, a first respective number of obstacles in all directions given a respective radial profile.

Every pixel or image coordinate system to the real world coordinate system may be achieved by matrix multiplication. For example, if a pixel location in the image is p, then the corresponding world location may be understood as q=Qp, where Q may be understood as the transformation metric. Similarly p=Q\hat{ }(−1)q.

A respective radial profile may be understood as a region determined by a direction from a reference point or location in an image, where the direction may be specified numerically as an angle, or as a cardinal direction with reference to a suitable coordinate space.

For example, given a pixel in an image, the first node 111 may check the radial profile up to a distance r along east, west, north, south, north-east, south-east, north-west and south-west directions. The first node 111 may then calculate the number of obstacles, e.g., walls, in all directions.

The determining in this Action 203 of the fourth information may also comprise determining 203b, for every pixel in one or more images comprised in the first radio coverage data based on the determined first respective number of obstacles, a respective density of obstacles, e.g., a wall region density. The respective density of obstacles may be determined as the minimum of the number of obstacles, e.g., walls, in all the directions. The respective density of obstacles may be specified as a number, such as ‘r’ walls, per unit area or pixels.

The determining in this Action 203 of the fourth information may further comprise determining 203c the respective set of one or more zones 161 as a respective number of zones per floor map based on the determined respective density of obstacles per pixel. In other words, the floor map may then be divided in multiple regions or zones Zₒ, Z₁, Z₂ . . . Zₘ₋₁, where a Z zone may be understood to be a region where the number of obstacles, e.g., walls, up to distance r may be l, having corresponding area Aₗ. The final outcome may then be Z, a floor map zone image where, Z⊆{Zₒ, Z₁, Z₂ . . . Zₘ₋₁}. m may be understood to be a number of the respective set of one or more zones 161.

The variable “l” may be understood to be a discrete variable, where it may be understood to correspond to the minimum number of obstacles along all directional radial profiles, in area Aₗ. Also as ‘l’ may be understood to be up to distance ‘r’, it may be understood to imply that ‘A_l=pi*r\hat{ }2’.

By determining the respective set of one or more zones 161 in this Action 203, the first node 111 may then be enabled to ultimately train the ML model that may enable to plan the provision of radio coverage to a space for which a floor plan may not be available, but for which information on the existence of different zones may be provided as input. It may be understood that different zones, each having different density of obstacles, may require more or less radio antennas in order to receive proper radio coverage. By extracting the respective set of one or more zones 161 in this Action 203, the ML model may eventually be enabled to be trained using this fourth information, and learn what may be the optimal number of radio antennas that may be required for a space 170, given the number and characteristics of zones it may have. That is, to train an ML model that may then be independent of the existence of a floor plan in order to estimate how many radio antennas may be necessary to provide radio coverage to a space, bearing in mind the existence of different zones or areas of uneven density of obstacles.

### Action 204

In this Action 204, the first node 111 determines, using ML, and the first radio coverage data from the one or more first communications networks 120, an ML model. The ML model is to estimate a number of the one or more radio antennas 142 necessary to provide radio coverage to the space 170. In other words, the first node 111, in this Action 204 may build a model that may estimate the number of first radio antennas 142 for the various zones.

The determining in this Action 204 may be understood as calculating, deriving, estimating or similar. The ML algorithm used may be implemented by the solution of optimisation problem(s) that may involve the minimisation or maximisation of function(s) of the variables involved, to estimate the number of radio antennas, subject to one or more constraints defined by functions or bounds on the one or more variables involved.

The determining in this Action 204 of the ML model may be based on the extracted first information, second information and third information in Action 202.

The determining in this Action 204 of the ML model may comprise a training phase, during which the ML model may be trained, and an inference phase.

The inputs to the training phase may be understood to be the first radio coverage data, that is, the network design files. The training during the training phase may be performed iteratively, with each pool of collected radio coverage data.

The inference phase may be understood as a phase wherein a respective ML model may be executed, or used, to make a particular prediction or detection. The inference phase may be reached once a desired respective accuracy level of the ML model may have been reached.

The estimate is to be performed in the absence of a floor plan corresponding to the space 170. That is, while during the training phase the ML model may use as input the information extracted per floor plan of the one or more floor plans 121, once the ML model may have been trained, the ML model may be understood to be able to estimate the number of the one or more radio antennas 142 necessary to provide radio coverage to the space 170 in the absence of a floor plan corresponding to the space 170. This may be understood to be advantageous, as it may render the inferences independent of the availability of the floor plan, which may not be available due to privacy and/or security concerns, and/or which in any event, may be take time to be obtained. Therefore, the estimation process may be simplified and performed more effectively.

In some embodiments, the determining in this Action 204 of the ML model may be based on the determined fourth information in Action 203.

In some of such embodiments, the determined ML model may be to estimate the number of the respective one or more radio antennas 142 necessary to provide radio coverage to the space 170, per zone.

In a first group of embodiments, the first node 111 may adopt a first approach to determine the ML model in this Action 204. According to the first approach, the determining in this Action 204 of the ML model may be performed as follows.

Let λₗ be a rate of first radio antennas 141 per unit area, given a zone Zₗ.

Considering an i^{th} floor map have an area Aᵢ, the floor map may be divided into multiple regions as mentioned in the previous Action 203, with respective area (Aᵢ₀, Aᵢ₁, Aᵢ₂ . . . Aᵢ₍ₘ₋₁₎. Every zone Z may be understood to have an associated area A.

kᵢ may be understood to be the number of the respective set of one or more first radio antennas 141 in the i^{th} floor map.

The ML model may be understood to involve solving an optimization problem involving minimization of a loss function of the estimated number of radio antennas, subject to constraints that may enforce bounds derived from a pathloss model, in the various zones identified from a floor plan. Particularly, according to the first approach, the determining in this Action 204 of the ML model may be based on an optimization of pathloss in the space 170 according to the following formula:

$$\hat{λ} = {arg min}_{λ} ℒ ( λ )$$

$$ℒ = {‖ A λ - k ‖}_{1}$$

$$wherein :$$

$$λ = {[ {λ}_{0} , {λ}_{1} , {λ}_{2} … {λ}_{m - 1} ]}^{T}$$

$${λ}_{l} = α 1 {0}^{l * β}$$

$${\overline{λ}}_{0} \leq {λ}_{1} \leq {\overline{λ}}_{∞}$$

In the formulas above:
\hat{λ} may be understood to be the estimated number of the one or more radio antennas 142,
λ may be understood to be the number of one or more first radio antennas 141,
l may be understood to be the first respective number of the obstacles 151, e.g., walls, corresponding to zone Zₗ,
λₗ may be understood to be the number of radio antennas given l obstacles as obtained from a propagation model,
α may be understood to be a path loss factor,
β may be understood to be a wall loss factor,
\tilde{λ} may be understood to be the number of first antennas per unit area given l obstacles using a propagation model,
λᵣ may be understood to be enforcing a bound on the estimated value of the number of radio antennas 142,
   \hat{λ}=[\hat{λ}₀, \hat{λ}₁, \hat{λ}₂ . . . \hat{λ}ₘ₋₁] may be estimated with a constrained optimization problem which may be defined as:

$$A = [ \begin{matrix}{A}_{00} & … & {A}_{0 m - 1} \\ ⋮ & ⋱ & ⋮ \\ {A}_{( n - 1 ) 0} & … & {A}_{( n - 1 ) m - 1}\end{matrix} ] k = {[ \begin{matrix}{k}_{0} ,\end{matrix} … , {k}_{( n - 1 )} ]}^{T}$$

wherein:
Aᵢₗ may be understood to be a respective space, e.g., an area, of the i^{th} floor map and l^{th} zone, and
n may be understood to be a number of floor maps, and wherein,
λ̅ₗ may act as a constraint in the above optimization problem and may be defined as:

$${\overline{λ}}_{r} = \frac{1}{π {D}_{l}^{2}}$$

$$wherein ,$$

$${D}_{r} = {10}^{{P}_{t} - RSRP - {PL}_{0} - BL - FM - r * MA / 20}$$

wherein:
Dₗ may be understood to be a distance from a first radio antenna 141 given l obstacles 151, e.g., walls and a device,
Pₜ may be understood to be a power emitted by the one or more first radio antennas 141 in the i^{th} floor map,
Reference Signal Received Power (RSRP) may be understood to be a power predicted to be received by a device, of the respective plurality of devices 130 in the i^{th} floor map, at the distance D
PL₀ may be understood to be a path loss at distance 1 meter and may be given by

$$20 {log}_{10} ( \frac{4 π f}{c} )$$

f is a frequency used for communication by the one or more first radio antennas 141 in the i^{th} floor map,
c may be understood to be the speed of light,
BL may be understood to be a body loss,
FM may be understood to be a fading margin, and
WA may be understood to be wall attenuation.

In a second group of embodiments, the first node 111 may adopt a second approach to determine the ML model in this Action 204. As mentioned in the first approach, λⱼ may be understood to be a rate of the first radio antennas 141 per unit area, given a zone Zⱼ, considering the i^{th} floor map may have an area Aᵢ, where the floor map may be divided into multiple regions with area (Aᵢ₀, Aᵢ₁, Aᵢ₂ . . . Aᵢ₍ₘ₋₁₎. kᵢ may be understood to be the number of the respective set of one or more first radio antennas 141 in the i^{th} floor map.

According to the second approach, the determining in this Action 204 of the ML model may be based on an optimization of pathloss in the space 170 according to the following formula:

$$\hat{λ} = {arg min}_{λ} - ℒ ( λ )$$

$$ℒ ( λ ) = {\sum }_{i = 1}^{n} \{ {\sum }_{i = 1}^{{k}_{i}} log λ {z}^{i} - {\int }_{A} λ ( z ) dz \}$$

$$where λ {z}_{l} = {e}^{α + l * β}$$

$$λ ( {z}_{l} ) = {λ}_{l} = λ ( z ) if z ∈ {Z}_{l}$$

$$and λ ( {z}^{j} ) = {λ}_{l} = λ ( {z}_{l} ) if {z}^{j} ∈ {Z}_{l}$$

wherein,
\hat{λ} may be understood to be estimated number of the one or more radio antennas 142,
λ may be understood to be number of one or more first radio antennas 141,
n may be understood to be a number of floors maps,
j may be understood to be a counter on the number of one or more first radio antennas 141 in the i^{th} floor map,
z^{j} may be understood to be a location of the j^{th} first radio antenna in the floor map zone image Z,
z may be understood to be a location in the floor map zone image Z,
Zₗ may be understood to be a location in the floor map corresponding to zone Zₗ,
α may be understood to be a path loss factor,
l may be understood to be the first respective number of the obstacles 151 corresponding to zone Zₗ,
β may be understood to be a wall loss factor,
λₗ may be understood to be the number of first antennas 141 per unit area for the l^{th} zone,

By determining the ML model to estimate the number of the one or more radio antennas 142 necessary to provide radio coverage to the space 170 in this Action 204, the first node 111 may be enabled to plan the radio coverage in any space, accurately, rapidly, and without higher end hardware requirements. Advantageously, the planning may be understood to not require a floorplan of the space, or its simulation. Hence, the planning process may be enabled to be simplified and expedited, enabling any party wishing to obtain the planning, to do so effectively, without having to incur into privacy and/or security issues.

Action 205 In this Action 205, the first node 111 may obtain, once the ML model may have been determined to have the desired accuracy level, second radio coverage data. The second radio coverage data may be to be used as input for the determined ML model. The second radio coverage data may be understood to be less than, or simpler than, the first radio coverage data that may have been used as input to train the ML model. Once the ML model may have been trained, the inferencing of the ML model may be understood to be enabled to be performed in a simplified and expedited manner.

The second radio coverage data may comprise fifth information indicating the target space 172. The target space 172 may be understood to be where radio coverage may have to be provided by the number of one or more radio antennas 142 to be estimated by the ML model. The fifth information may comprise for example, area of floor corresponding to the space 172, number of floors and target RSRP. The target RSRP may be understood as the RSRP that may be desired to be achieved by the estimated one or more radio antennas 142 if they were to provide radio coverage to the space 172.

The second radio coverage data may also comprise sixth information. The sixth information may indicate one or more second zones in the target space 172. The sixth information may comprise for example, first sixth information indicating a first ratio of the target space, e.g., of the area corresponding to the target space 172, being classified as having a “normal” density of obstacles, second sixth information indicating a second ratio of the target space, e.g., of the area corresponding to the target space 172, being classified as having a “complex” density of obstacles, and third sixth information indicating a third ratio of the target space, e.g., of the area corresponding to the target space 172, being classified as having a “critical” density of obstacles. Normal may be understood in this context as having a first, lowest, range of density of obstacles, as well as a first, lowest, QoS requirement, e.g., the RSRP requirement may be looser, that is, lesser than that of the critical and complex. Complex may be understood in this context as a second, higher, range of density of obstacles and a second, higher, RSRP requirement in between that of normal and critical. Critical may be understood in this context as a third, stringent, RSRP requirement along with a higher density of obstacles. Each of the first range, the second range, and the third range may be obtained in this Action 205. In order to achieve better accuracy in terms of the estimated number of the one or more radio antennas 142, the first node 111 may apply an additional offset on the target RSRP value. This may be understood to be an additional parameter which may be tuned based on scenario.

Any of the first sixth information, the second sixth information, and the third sixth information, may further comprise, respectively, further information indicating a breakdown of the normal, complex, and critical areas, respectively, into a ratio of area for the type of surface in the respective floor plan. The type of surface in the respective floor plan may be such as, e.g., cubicles, auditoriums, conference rooms, lobby, corridors, and office spaces.

The second radio coverage data may further comprise seventh information. The seventh information may indicate a type of second radio antennas to be used to provide the coverage in the target space 172. The type of the second radio antennas may be understood to refer to indoor/outdoor, that is, small cell antenna, micro/macro or indoor type, etc.

In other words, in this Action 205, the first node 111 may solicit from the users inputs such as device type, zones and their corresponding area. Device type may be understood to refer to a category to which the device may belong, out of multiple categories, e.g. mobile, IoT sensor, URLLC device, Augmented Reality (AR)/Virtual Reality (VR) device etc.

The second radio coverage data may be understood to lack the one or more floor plans corresponding to the target space 172, as these may be understood to not be necessary in order to inference the trained ML model.

By obtaining the second radio coverage data in this Action 205, the first node 111 may then be enabled to use the ML model to infer the number of one or more radio antennas 142 necessary to provide radio coverage to the target space 172, as described in the next Action 205. This, while not requiring the floor plan corresponding to the target space 172, which has the advantages discussed earlier.

### Action 206

In this Action 206, the first node 111 may infer, in the absence of a floor plan corresponding to the target space 172, and using the determined ML model, the number of one or more radio antennas 142 necessary to provide radio coverage to the target space 172. Inferencing may be understood as executing, running or equivalent.

That is, given the user inputs and the parameters generated from the ML model, the first node 111 may estimate the number of one or more radio antennas 142.

For example, the inputs to the inference in this Action 206 may be, e.g., various zones and its areas (Aᵢₗ) in ith floor map, the rate of first radio antennas 141 per unit area for the various zones (\hat{λ}ₗ). Given the rate of first radio antennas 141 per zones \hat{λ}=[\hat{λ}₀, \hat{λ}₁, \hat{λ}₂ . . . \hat{λ}ₘ₋₁]^{T} and the areas of the corresponding zones of floor map Aᵢ=[Aᵢ₀, Aᵢ₁, Aᵢ₂ . . . Aᵢ₍ₘ₋₁₎], the first node 111 may then estimate the total number of one or more radio antennas 142 for floor map Aᵢ as A\hat{λ}.

By inferencing the number of one or more radio antennas 142 necessary to provide radio coverage to the target space 172 in this Action 206, the first node 111 may be enabled to plan the radio coverage in the target space 172, accurately, rapidly, and without higher end hardware requirements. Advantageously, the planning may be understood to not require a floorplan of the target space 172, or its simulation. Hence, the planning process may be enabled to be simplified and expedited, enabling any party wishing to obtain the planning, to do so effectively, without having to incur into privacy and/or security issues.

### Action 207

In this Action 207, the first node 111 may determine, based on the inferenced number of the one or more radio antennas 142 necessary to provide radio coverage to the target space 172, a set of materials necessary to provide the radio coverage to the target space 172 with the inferenced number of the one or more radio antennas 142. The set of materials may be understood as a Bill of Material (BOM). That is, in this Action 207, the first node 111, given the determined number of one or more radio antennas 142 may also estimate the BoM.

The set of materials may indicate, for example, associated number of baseband, indoor radio unit (IRU), fibre cable etc.

By determining the set of materials in this Action 207, the first node 111 may then be enabled to provide this information, so that the planning of the radio coverage for the target space 172 may be enabled to be implemented, in an expedited, accurate and simplified manner.

### Action 208

In this Action 208, the first node 111 provides an indication of the determined ML model to the second node 112 operating in the computer system 100.

Providing in this Action 208 may be understood as sending, for example, via the first link 116 or displaying, e.g., on an interface.

The provided indication may be one of: a) a first indication indicating the determined ML model and b) a second indication indicating the number of one or more radio antennas 142.

The first indication may comprise, for example, the parameters of the trained ML model, which the first node 111 may have stored in a memory. The first indication may be provided by the first node 111 in embodiments wherein the second 112 may use the determined ML model to perform inferencing for target spaces. The second indication may be provided by the first node 111 in embodiments wherein the first node 111 may have performed the inferencing itself.

The provided indication may indicate the inferenced number of the one or more radio antennas 142 necessary to provide radio coverage to the target space 172.

In embodiments wherein Action 207 may have been performed, the provided indication may further indicate the determined set of materials.

By providing the indication in this Action 208, the first node 111 may then enable the second node 112 to plan the radio coverage for the target space 172. This may be performed by either providing the first indication, thereby enabling the second node 112 to perform the inferencing of the number of one or more radio antennas 142 necessary to provide radio coverage to the target space 172, or by providing the second indication, and thereby enabling the second node 112 to enable itself to implement the radio coverage in the target space 172 with the inferenced number of number of one or more radio antennas 142 and optionally, the indicated set of materials.

Either way, the providing of the indication in this Action 208 may be understood to enable planning the radio coverage in the target space 172, accurately, rapidly, and without higher end hardware requirements. Advantageously, the planning may be understood to not require a floorplan of the space, or its simulation. Hence, the planning process may be enabled to be simplified and expedited, enabling any party wishing to obtain the planning, to do so effectively and accurately, without having to incur into privacy and/or security issues.

### Experiments and Results

The accuracy of estimation of embodiments herein has been tested in experiments conducted with primarily industrial data. The data comprised 24 sites, 93 floors and 1900 MHz as frequency used for communication by the one or more first radio antennas 141. Given 93 floor maps, a leave-one-out cross validation approach was used to estimate the performance. The results were as follows: within +1, +2, +3, +4 with respect to the ground truth the determined ML model was 61%, 76%, 87%, 89% of the times correct, correspondingly.

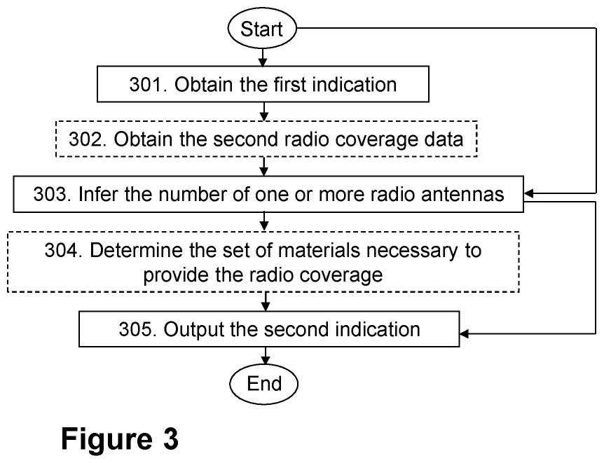

Embodiments of a computer-implemented method, performed by the second node 112, will now be described with reference to the flowchart depicted in FIG. 3. The method is for planning the radio coverage in the space 170. The second node 112 operates in the computer system 100.

Several embodiments are comprised herein. In some embodiments all the actions may be performed. In some embodiments, some actions may be optional. In FIG. 3, optional actions are indicated with dashed lines. It should be noted that the examples herein are not mutually exclusive. Components from one embodiment may be tacitly assumed to be present in another embodiment and it will be obvious to a person skilled in the art how those components may be used in the other exemplary embodiments. One or more embodiments may be combined, where applicable. All possible combinations are not described to simplify the description. For example, in some embodiments, each zone may correspond to a respective density level of obstacles, e.g., walls.

### Action 301

In this Action 301, the second node 112 obtains, from the first node 111 operating in the computer system 100, the indication of the determined ML model. The ML model is to estimate the number of the one or more radio antennas 142 necessary to provide radio coverage to the space 170. The estimate is to be performed in the absence of the floor plan corresponding to the space 170.

That the indication is of the “determined” ML model may be understood to mean that the indication is of the trained ML model.

The obtaining, e.g., receiving may be performed, e.g., via the first link 161.

In some embodiments, the determined ML model may be to estimate the number of the respective one or more radio antennas 142 necessary to provide radio coverage to the space 170, per zone.

By obtaining the indication in this Action 301, the second node 112 may be enabled to plan the radio coverage for the target space 172. This may be performed by either obtaining the first indication, thereby enabling the second node 112 to perform the inferencing of the number of one or more radio antennas 142 necessary to provide radio coverage to the target space 172, or by obtaining the second indication, and thereby enabling the second node 112 to enable itself to implement the radio coverage in the target space 172 with the inferenced number of number of one or more radio antennas 142 and optionally, the indicated set of materials.

### Action 302

In this Action 302, the second node 112 may obtain the second radio coverage data. The second radio coverage data may comprise i) the fifth information indicating the target space 172 where radio coverage that may have to be provided by the number of one or more radio antennas 142 to be estimated by the ML model. The second radio coverage data may further comprise ii) the sixth information indicating the one or more second zones in the target space 172. The second radio coverage data may additionally comprise iii) the seventh information indicating the type of second radio antennas to be used to provide the coverage in the target space 172.

That is, in this Action 302, the second node 112 may receive a new set of data, which the second node 112 may use to run the indicated ML model to make predictions and/or detections with fresh, and reduced, radio coverage data.

### Action 303

In this Action 303, the second node 112 infers, in the absence of the floor plan corresponding to the target space 172, and using the determined ML model, the number of one or more radio antennas 142 necessary to provide radio coverage to the target space 172.

The inferencing in this Action 303 may be based on the obtained fifth information, sixth information and seventh information from Action 302.

By inferencing the number of one or more radio antennas 142 necessary to provide radio coverage to the target space 172 in this Action 303, the second node 112 may enable to plan, either itself, or a user of the second node 112, the radio coverage in the target space 172, accurately, rapidly, and without higher end hardware requirements. Advantageously, the planning may be understood to not require a floorplan of the target space 172, or its simulation. Hence, the planning process may be enabled to be simplified and expedited, enabling any party wishing to obtain the planning, to do so effectively, without having to incur into privacy and/or security issues.

### Action 304

In some embodiments, in this Action 304, the second node 112 may determine, based on the inferenced number of the one or more radio antennas 142 necessary to provide radio coverage to the target space 172, the set of materials necessary to provide the radio coverage to the target space 172 with the inferenced number of the one or more radio antennas 142.

### Action 305

In this Action 305, the second node 112 outputs the second indication based on a result of the inferencing in Action 303. The second indication indicates the inferenced number of the one or more radio antennas 142 necessary to provide radio coverage to the target space 172. In some embodiments, the output second indication may further indicate the determined set of materials in Action 304.

By outputting the second indication in this Action 305, the second node 112 may then enable to implement the radio coverage in the target space 172 with the inferenced number of number of one or more radio antennas 142 and optionally, the indicated set of materials.

The providing of the second indication in this Action 305 may be understood to enable planning the radio coverage in the target space 172, accurately, rapidly, and without higher end hardware requirements. Advantageously, the planning may be understood to not require a floorplan of the space, or its simulation. Hence, the planning process may be enabled to be simplified and expedited, enabling any party wishing to obtain the planning, to do so effectively and accurately, without having to incur into privacy and/or security issues.

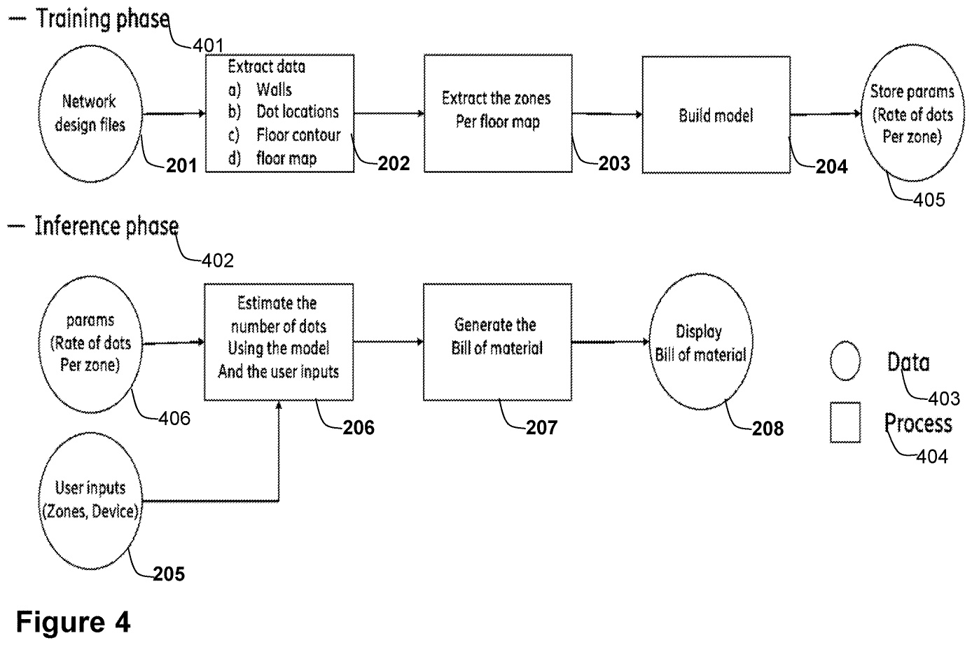

FIG. 4 is a schematic diagram depicting a non-limiting example of the method performed by the first node 111, according to embodiments herein. As described earlier, there may be 2 phases to the method performed by the first node 111, as illustrated in FIG. 4: a training phase 401 and an inference phase 402. In each of the phases, the actions in circles denote data 403 collection or output, whereas the actions in squares denote process 404 actions. With regards to the training phase 401, the inputs may be the first radio coverage data, that is, the network design files, which may be obtained according to Action 201. Next, according to Action 202, the first node 111 may extract the obstacles 151, e.g., walls, the respective location of the respective set of one or more first radio antennas 141, indicated as “dots” in FIG. 4, the floor contour and the one or more floor plans 121 from the design files. Next, according to Action 203, the first node 111 may, using the above information, extract the various zones per floor map. The first node 111 may then, according to Action 204, build the ML model that may estimate the number of number of the respective one or more radio antennas 142 necessary to provide radio coverage to the space 170, for the various zones, per zone. The first node 111 may then, in Action 405, store the parameters (params) obtained from the build ML model, e.g., the rate of one or more radio antennas 142 per zone. With regards to the inference phase 402, the inputs such as device type, zones and their corresponding area may be solicited from the users according to Action 205. Given the user inputs obtained according to Action 205, e.g., the zones and the devices, and the parameters generated from the determined ML model in Action 204, and then retrieved at 406, the first node 111 may then estimate, according to Action 206, the number of the respective one or more radio antennas 142 necessary to provide radio coverage to the target space 172. Given the number of the respective one or more radio antennas 142 necessary to provide radio coverage to the target space 172, the first node 111 may then also estimate, according to Action 207, the BoM, and, according to Action 208, provide the indication of the determined ML model to the second node 112 by displaying the BoM on a screen of the first node 111. In this particular example, the first node 111 may be the same node as the second node 112.

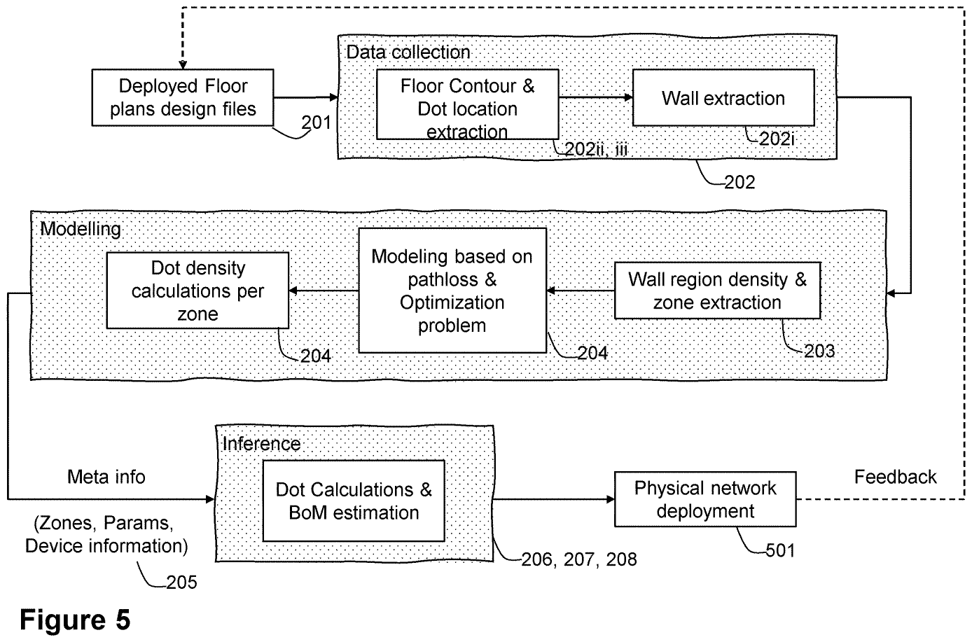

FIG. 5 is a schematic diagram depicting a further detailed non-limiting example of the method performed by the first node 111, according to embodiments herein, for estimation of multiple zones within a floorplan. As described earlier, the first node 111 may obtain, according to Action 201, design files comprising the first radio coverage data such as deployed floor plans. Next, according to Action 202, the first node 111 may initiate a data collection phase. In the data collection phase, according to Actions 202 ii and Action 202 iii respectively, the first node 111 may use image processing modules to extract the locations of the respective set of one or more first radio antennas 141, indicated as “dots” in FIG. 5, and the floor contour, from the respective images. In the data collection phase, the first node 111 may also use image processing modules to, according to Actions 202 i, extract the obstacles 151, e.g., walls, from the floor plans. Next, the first node 111 may initiate a modelling phase, first by processing, according to Action 203, the wall segmentation images to extract the wall region density. The first node 111 may then estimate multiple zones within a floor map using the wall region density. The first node 111 may then, according to Action 204, build the ML model based on pathloss and the optimization problem, as described. The first node 111 may then obtain from the build ML model, e.g., the rate of one or more radio antennas 142 per zone, referred to as “dots” in FIG. 5. With regards to the inference phase, the inputs such as device type and zones may be solicited from the users according to Action 205. Given the user inputs obtained according to Action 205, e.g., the zones and the devices, and the parameters generated from the determined ML model in Action 204, the first node 111 may then estimate, according to Action 206, the number of the respective one or more radio antennas 142 necessary to provide radio coverage to the target space 172, which floorplan may itself not be available. Given the number of the respective one or more radio antennas 142 necessary to provide radio coverage to the target space 172, the first node 111 may then also estimate, according to Action 207, the BoM, and, according to Action 208, provide the indication of the determined ML model to the second node 112 by, for example, displaying the BOM on the screen of the first node 111. This may then lead at 501, in the deployment in the physical network of the estimated respective one or more radio antennas 142, which may in turn generate additional radio coverage data which may be feedback into the first node 111 as additional first radio coverage data to further refine the ML model.

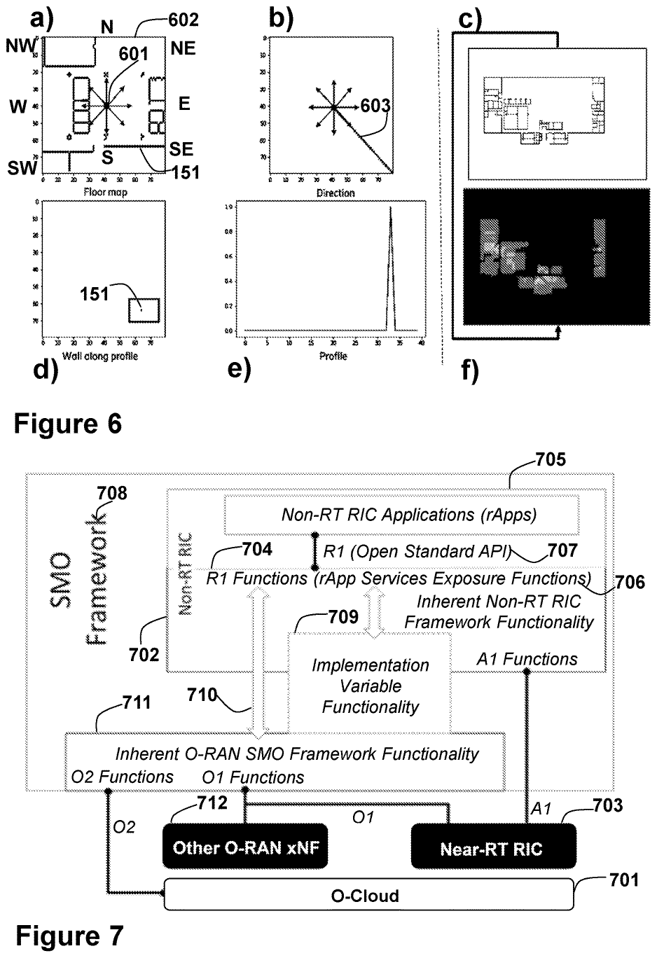

FIG. 6 is a schematic diagram depicting a further detailed non-limiting example of the method performed by the first node 111, according to embodiments herein, to extract multiple zones within a floor map using wall region density. The actions performed by the first node 111 may be as follows. Given a pixel 601 in an image 602, which is a zoomed view of a region of the floor plan image shown in panel c), comprised in the first radio coverage data, depicted in panel a) of FIG. 6, the first node 111 may, according to Action 203a, check the radial profile up to a distance r 603 along east (E), west (W), north (N), south(S), north-east (NE), south-east (SE), north-west (NW) and south-west (SW) directions, as depicted in panel b). Then, the first node 111 may calculate the first respective number of obstacles 151, e.g., walls, in all directions. The first node 111 may then, according to Action 203b, determine the respective density of obstacles, e.g., the wall region density, as the minimum of the number of obstacles, e.g., walls in all the directions. The floor map may then, according to Action 203c, be then divided between multiple regions or zones Zₒ, Z₁, Z₂ . . . Zₘ₋₁, as the respective set of one or more zones 161, where Z zone may be understood to be the region where the number of obstacles, e.g., walls, up to distance r is l, having corresponding area AI. As an illustrative example, panel d) indicates an obstacle 151, such as a wall, and panel e) the corresponding radial profile from the pixel of reference 601. The final outcome is Z, the floor map zone image depicted in panel f), where, Z⊆{Zₒ, Z₁, Z₂ . . . Zₘ₋₁}.

FIG. 7 is a schematic illustration depicting a Non Real-Time RAN Intelligent Controller (Non-RT RIC architecture), which may be used to implement the methods performed by any of the first node 111 and the second node 112, according to embodiments herein. The Open Radio Access Network (O-RAN) Alliance may be understood to define Open-Cloud (O-Cloud) 701 as a cloud computing platform which may be comprised of a collection of physical infrastructure nodes that may meet O-RAN requirements to host the relevant O-RAN functions, the supporting software components, and the appropriate management and orchestration functions. The Non-RT RIC 702 may be understood to enable non-real-time control and optimization of RAN elements and resources, and may include AI/ML workflow including model training and updates, and policy-based guidance of applications/features in the Near-RT RIC 703. The functionality 704 of the non-RT RIC 702 may be understood to be directly responsible for driving what may be sent and received across the A1 interface. The Non-RT RIC 702 may allow applications to run on it. These applications may be called “rApps” 705, where ‘r’ may be understood to stand for RAN. The Non-RT RIC may expose Service Management and Orchestration (SMO) Framework functions to “rApps” via a set of “rApps” Services Exposure” functions 706 over the R1 interface 707. The R1 interface 707 may be understood to be the only interface between an “rApps” 705 and the functionality of the Non-RT RIC 702 and SMO 708, and defined to meet all functional needs of rApps, with appropriate interface extensibility capabilities as needed. Embodiments herein may be implemented as an rApp, so that a mobile operator or enterprise may automate network planning activities and enhance capabilities, such as auto-commissioning of sites and automation of other workflows. The O-RAN implementation may improve network planning productivity to accelerate 5G rollout. A1 may be understood to be an interface between non-RT RIC 702 and near RT RIC 703. It may be used for policy transmission and E2 information exchange between these two entities. The O1 interface may be used to transfer performance related statistics towards the SMO. The O2 interface may be understood to be between the SMO and the infrastructure management framework supporting O-RAN virtual network functions. Implementation Variable Functionality 709 may be understood to refer to that which may be left as an SMO Framework implementation decision whether a particular R1-exposed functionality may be sourced from the Non-RT RIC 702 Framework or not. Examples may include functions such as “Data Sharing”, “Analytic Services”, “Policy”, “RAN Inventory”, “etc. Interfaces 710 may be within the scope of the Non-RT RIC 702 Framework's rApp Services Exposure Functions 706 to expose all required services of the SMO framework, even those that are not or may not be associated with the Non-RT RIC framework itself 702. Inherent O-RAN SMO Framework Functionality 711 may be understood to refer to functionality which may be considered “inherent” to the SMO framework itself, but not the Non-RT RIC 702 Framework. That is, an indication that a particular R1-exposed functionality may be not sourced from the Non-RT RIC 702 framework. Other O-RAN Xn 712 may be understood to include network functions such as E2 nodes e.g., O-eNB, O-CU/O-DU.

As a summarized overview of the foregoing, embodiments herein may enable to accurately estimate the number of radio antennas necessary to provide radio coverage to a space, without using the floorplan corresponding to the space, or its simulation. A given venue and floor plan may be broken into granular levels, such as different zones, based on their characteristics. An ML model may be trained by converting the floorplans into multiple non-overlapping regions which may align planning of a single floor/venue as per QoS/coverage requirements of specific zones of that floor/venue. The determination of the ML model may use a combination of a path loss model and a data driven approach to estimate the number of radio antennas 142. Feedback and retraining may help in tuning the feature set of the ML model to further enhance the accuracy of the ML model.

A customer feedback loop may be incorporated, where the inputs from the customers may be used to improve the trained model.

Certain embodiments herein may provide one or more of the following technical advantage(s). A technical advantage may be understood to be that the planning approach of radio coverage in a space according to embodiments herein may be understood to be very fast, and may not have higher end hardware requirements. Advantageously, the planning may be understood to not require floorplans or their simulation.

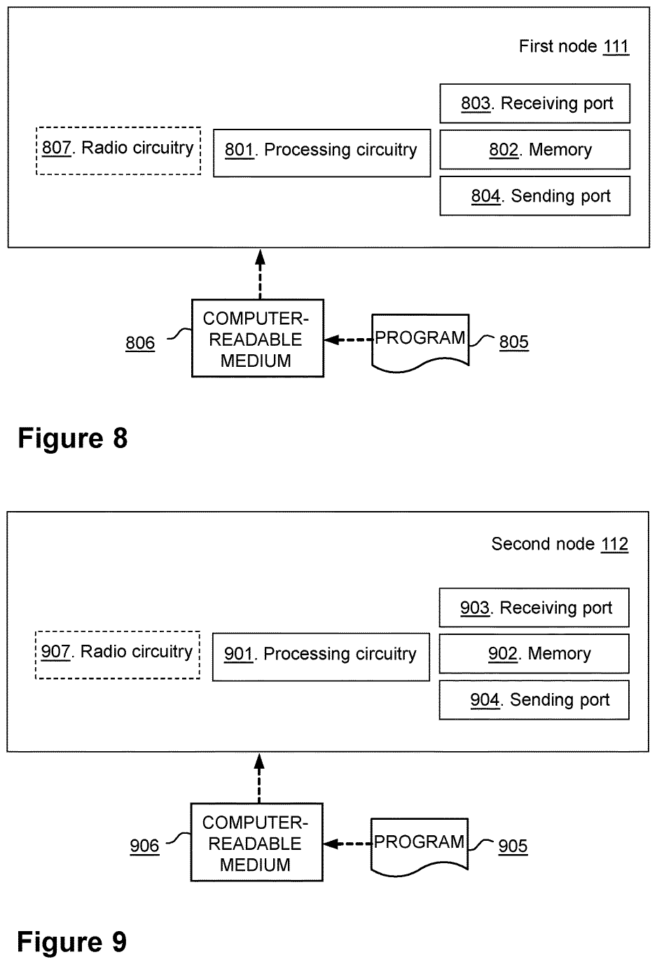

FIG. 8 depicts an example of the arrangement that the first node 111 may comprise to perform the method described in FIG. 2 and/or FIGS. 4-7. The first node 111 may be understood to be for planning radio coverage in the space 170. The first node 111 is configured to operate in the computer system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111, and will thus not be repeated here. For example, in some embodiments, each zone may be configured to correspond to a respective density level of obstacles, e.g., walls.

The first node 111 is configured to determine, using ML, and the first radio coverage data from the one or more first communications networks 120, the ML model to estimate the number of one or more radio antennas 142 necessary to provide radio coverage to the space 170. The estimate is configured to be performed in the absence of the floor plan corresponding to the space 170.

The first node 111 is also configured to provide the indication of the ML model configured to be determined to the second node 112 configured to operate in the computer system 100. In some embodiments, the first node 111 may be further configured to obtain the first radio coverage data. The first radio coverage data may be configured to comprise the one or more floor plans 121 configured to comprise the respective distribution of the respective set of one or more first radio antennas 141. The first radio coverage data may be configured to also comprise the respective set of radio performance data configured to be collected from the respective plurality of devices 130. The respective plurality of devices 130 may be configured to operate in the respective spaces configured to be defined by the one or more floor plans 121. Each of the one or more floor plans 121 may be configured to comprise the respective distribution of obstacles 151.

In some embodiments, the first node 111 may be further configured to extract, from the first radio coverage data configured to be obtained, and per floor plan of the one or more floor plans 121: the first information, the second information and the third information. The first information may be configured to indicate the respective distribution of the obstacles 151. The first information may be configured to comprise at least one of: a) the number of the obstacles 151 and b) the distribution of the obstacles 151. The second information may be configured to indicate the respective location of the respective set of one or more first radio antennas 141. The third information may be configured to indicate the respective contour of the one or more floor plans 121. The extracting may be configured to be based on image processing. The determining of the ML model may be configured to be based on the first information, the second information and the third information configured to be extracted.

In some embodiments, the first node 111 may be further configured to determine, per floor plan of the one or more floor plans 121, and based on the first information, the second information and the third information configured to be extracted, the fourth information. The fourth information is configured to indicate the respective set of one or more zones 161. Each zone may be configured to correspond to the respective density level of the obstacles 151. The determining of the ML model may be configured to be based on the fourth information configured to be determined.

In some embodiments, the determined ML model may be configured to be to estimate the number of the respective one or more radio antennas 142 necessary to provide radio coverage to the space 170, per zone.

In some embodiments, the determining of the fourth information may be configured to comprise: a) determining, for every pixel in the one or more images configured to be comprised in the first radio coverage data, the first respective number of obstacles in all directions given the respective radial profile; b) determining, for every pixel in the one or more images configured to be comprised in the first radio coverage data based on the first respective number of obstacles configured to be determined, the respective density of obstacles; and c) determining the respective set of one or more zones 161 as the respective number of zones per floor map based on the respective density of obstacles configured to be determined per pixel.

In some embodiments, the determining of the ML model may be configured to comprise the training phase, during which the ML may be configured to be trained, and the inference phase, wherein the inference phase may be configured to be reached once the desired accuracy level of the ML model may be reached.

In some embodiments, the first node 111 may be further configured to obtain, once the ML model may have been determined to have the desired accuracy level, the second radio coverage data. The second radio coverage data may be to be used as input for the ML model configured to be determined. The second radio coverage data may be configured to comprise the fifth information, the sixth information and the seventh information. The fifth information may be configured to indicate the target space 172 where radio coverage may be to be provided by the number of one or more radio antennas 142 configured to be estimated by the ML model. The sixth information may be configured to indicate the one or more second zones in the target space 172. The seventh information may be configured to indicate the type of second radio antennas to be used to provide the coverage in the target space 172.

In some embodiments, the first node 111 may be further configured to infer, in the absence of the floor plan corresponding to the target space 172, and using the determined ML model, the number of one or more radio antennas 142 necessary to provide radio coverage to the target space 172. The indication configured to be provided may be configured to indicate the number of the one or more radio antennas 142 necessary to provide radio coverage to the target space 172 configured to be inferenced.

In some embodiments, the first node 111 may be further configured to determine, based on the number of the one or more radio antennas 142 necessary to provide radio coverage to the target space 172 configured to be inferenced, the set of materials necessary to provide the radio coverage to the target space 172 with the number of the one or more radio antennas 142 configured to be inferenced. The indication configured to be provided may be further configured to indicate the set of materials configured to be determined.

In some embodiments, the indication configured to be provided may be configured to be one of: a) the first indication configured to indicate the determined ML model and b) the second indication configured to indicate the number of one or more radio antennas 142.

In some embodiments, the determining of the ML model may be configured to be based on the optimization of pathloss in the space 170.

The embodiments herein in the first node 111 may be implemented through one or more processors, such as a processing circuitry 801 in the first node 111 depicted in FIG. 8, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 802 comprising one or more memory units. The memory 802 is arranged to be used to store obtained information, store data, configurations, schedulings, and applications etc. to perform the methods herein when being executed in the first node 111.

In some embodiments, the first node 111 may receive information from, e.g., the second node 112, any of the one or more first radio antennas 141, any of the devices in the plurality of devices 130, and/or another structure in the computer system 100, through a receiving port 803. In some embodiments, the receiving port 803 may be, for example, connected to one or more antennas in first node 111. In other embodiments, the first node 111 may receive information from another structure in the computer system 100 through the receiving port 803. Since the receiving port 803 may be in communication with the processing circuitry 801, the receiving port 803 may then send the received information to the processing circuitry 801. The receiving port 803 may also be configured to receive other information.

The processing circuitry 801 in the first node 111 may be further configured to transmit or send information to e.g., the second node 112, any of the one or more first radio antennas 141, any of the devices in the plurality of devices 130, and/or another structure in the computer system 100, through a sending port 804, which may be in communication with the processing circuitry 801, and the memory 802.

Those skilled in the art will also appreciate that the units comprised within the first node 111 described above as being configured to perform different actions, may refer to a combination of analog and digital circuits, and/or one or more processors configured with software and/or firmware, e.g., stored in memory, that, when executed by the one or more processors such as the processing circuitry 801, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the first node 111 described above as being configured to perform different actions described above may be implemented as one or more applications running on one or more processors such as the processing circuitry 801.

Thus, the methods according to the embodiments described herein for the first node 111 may be respectively implemented by means of a computer program 805 product, comprising instructions, i.e., software code portions, which, when executed on at least one processing circuitry 801, cause the at least one processing circuitry 801 to carry out the actions described herein, as performed by the first node 111. The computer program 805 product may be stored on a computer-readable storage medium 806. The computer-readable storage medium 806, having stored thereon the computer program 805, may comprise instructions which, when executed on at least one processing circuitry 801, cause the at least one processing circuitry 801 to carry out the actions described herein, as performed by the first node 111. In some embodiments, the computer-readable storage medium 806 may be a non-transitory computer-readable storage medium, such as a CD ROM disc, or a memory stick. In other embodiments, the computer program 805 product may be stored on a carrier containing the computer program 805 just described, wherein the carrier is one of an electronic signal, optical signal, radio signal, or the computer-readable storage medium 806, as described above.

The first node 111 may comprise a communication interface configured to facilitate, or an interface unit to facilitate, communications between the first node 111 and other nodes or devices, e.g., the second node 112, any of the one or more first radio antennas 141, any of the devices in the plurality of devices 130, and/or another structure in the computer system 100. The interface may, for example, include a transceiver configured to transmit and receive radio signals over an air interface in accordance with a suitable standard.

In other embodiments, the first node 111 may comprise a radio circuitry 807, which may comprise e.g., the receiving port 803 and the sending port 804.

The radio circuitry 807 may be configured to set up and maintain at least a wireless connection with the second node 112, any of the one or more first radio antennas 141, any of the devices in the plurality of devices 130, and/or another structure in the computer system 100. Circuitry may be understood herein as a hardware component.

Hence, embodiments herein also relate to the first node 111 operative to operate in the computer system 100. The first node 111 may comprise the processing circuitry 801 and the memory 802, said memory 802 containing instructions executable by said processing circuitry 801, whereby the first node 111 is further operative to perform the actions described herein in relation to the first node 111, e.g., in FIG. 2 and/or FIGS. 4-7.

FIG. 9 depicts an example of the arrangement that the second node 112 may comprise to perform the method described in FIG. 3 and/or FIGS. 4-7. The second node 112 may be understood to be for planning radio coverage in the space 170. The second node 112 is configured to operate in the computer system 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the second node 112, and will thus not be repeated here. For example, in some embodiments, the actuations may be configured to comprise an HO actuation.

The second node 112 is configured to obtain, from the first node 111 configured to operate in the computer system 100, the indication of the determined ML model. The ML model is configured to estimate the number of the one or more radio antennas 142 necessary to provide radio coverage to the space 170. The estimate is configured to be performed in the absence of the floor plan corresponding to the space 170.

The second node 112 is also configured to infer, in the absence of the floor plan corresponding to the target space 172, and using the determined ML model, the number of one or more radio antennas 142 necessary to provide radio coverage to the target space 172.

The second node 112 is further configured to output the second indication based on the result of the inferencing. The second indication is configured to indicate the number configured to be inferenced of the one or more radio antennas 142 necessary to provide radio coverage to the target space 172.

In some embodiments, the second node 112 may further configured to obtain the second radio coverage data configured to comprise the fifth information, the sixth information and the seventh information. The fifth information may be configured to indicate the target space 172 where radio coverage may be to be provided by the number of one or more radio antennas 142 configured to be estimated by the ML model. The sixth information may be configured to indicate the one or more second zones in the target space 172. The seventh information may be configured to indicate the type of second radio antennas to be used to provide the coverage in the target space 172. The inferencing may be configured to be based on the fifth information, the sixth information and the seventh information configured to be obtained.

In some embodiments, the second node 112 may further configured to determine, based on the number of the one or more radio antennas 142 necessary to provide radio coverage to the target space 172 configured to be inferenced, the set of materials necessary to provide the radio coverage to the target space 172 with the inferenced number of the one or more radio antennas 142. The output second indication may be configured to further indicate the set of materials configured to be determined.

In some embodiments, the determined ML model may be configured to estimate the number of the respective one or more radio antennas 142 necessary to provide radio coverage to the space 170, per zone.

The embodiments herein in the second node 112 may be implemented through one or more processors, such as a processing circuitry 901 in the second node 112 depicted in FIG. 9, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 902 comprising one or more memory units. The memory 902 is arranged to be used to store obtained information, store data, configurations, schedulings, and applications etc. to perform the methods herein when being executed in the second node 112.

In some embodiments, the second node 112 may receive information from, e.g., the first node 111, any of the one or more first radio antennas 141, any of the devices in the plurality of devices 130, and/or another structure in the computer system 100, through a receiving port 903. In some embodiments, the receiving port 903 may be, for example, connected to one or more antennas in second node 112. In other embodiments, the second node 112 may receive information from another structure in the wireless communications network 100 through the receiving port 903. Since the receiving port 903 may be in communication with the processing circuitry 901, the receiving port 903 may then send the received information to the processing circuitry 901. The receiving port 903 may also be configured to receive other information.

The processing circuitry 901 in the second node 112 may be further configured to transmit or send information to e.g., the first node 111, any of the one or more first radio antennas 141, any of the devices in the plurality of devices 130, and/or another structure in the computer system 100, through a sending port 904, which may be in communication with the processing circuitry 901, and the memory 902.

Those skilled in the art will also appreciate that the units comprised within the second node 112 described above as being configured to perform different actions, may refer to a combination of analog and digital circuits, and/or one or more processors configured with software and/or firmware, e.g., stored in memory, that, when executed by the one or more processors such as the processing circuitry 901, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units comprised within the second node 112 described above as being configured to perform different actions described above may be implemented as one or more applications running on one or more processors such as the processing circuitry 901.

Thus, the methods according to the embodiments described herein for the second node 112 may be respectively implemented by means of a computer program 905 product, comprising instructions, i.e., software code portions, which, when executed on at least one processing circuitry 901, cause the at least one processing circuitry 901 to carry out the actions described herein, as performed by the second node 112. The computer program 905 product may be stored on a computer-readable storage medium 906. The computer-readable storage medium 906, having stored thereon the computer program 905, may comprise instructions which, when executed on at least one processing circuitry 901, cause the at least one processing circuitry 901 to carry out the actions described herein, as performed by the second node 112. In some embodiments, the computer-readable storage medium 906 may be a non-transitory computer-readable storage medium, such as a CD ROM disc, or a memory stick. In other embodiments, the computer program 905 product may be stored on a carrier containing the computer program 905 just described, wherein the carrier is one of an electronic signal, optical signal, radio signal, or the computer-readable storage medium 906, as described above.

The second node 112 may comprise a communication interface configured to facilitate, or an interface unit to facilitate, communications between the second node 112 and other nodes or devices, e.g., the first node 111, any of the one or more first radio antennas 141, any of the devices in the plurality of devices 130, and/or another structure in the computer system 100. The interface may, for example, include a transceiver configured to transmit and receive radio signals over an air interface in accordance with a suitable standard.

In other embodiments, the second node 112 may comprise a radio circuitry 907, which may comprise e.g., the receiving port 903 and the sending port 904.

The radio circuitry 907 may be configured to set up and maintain at least a wireless connection with the first node 111, any of the one or more first radio antennas 141, any of the devices in the plurality of devices 130, and/or another structure in the computer system 100. Circuitry may be understood herein as a hardware component.

Hence, embodiments herein also relate to the second node 112 operative to operate in the wireless communications network 100. The second node 112 may comprise the processing circuitry 901 and the memory 902, said memory 902 containing instructions executable by said processing circuitry 901, whereby the second node 112 is further operative to perform the actions described herein in relation to the second node 112, e.g., in FIG. 3 and/or FIGS. 4-7.

When using the word “comprise” or “comprising”, it shall be interpreted as non-limiting, i.e., meaning “consist at least of”.

The embodiments herein are not limited to the above-described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1. A computer-implemented method, performed by a first node, the method being for planning radio coverage in a space, the first node operating in a computer system, the method comprising:
determining, using machine learning, ML, and first radio coverage data from one or more first communications networks, an ML model to estimate a number of one or more radio antennas necessary to provide radio coverage to the space, the estimate to be performed in the absence of a floor plan corresponding to the space; and
providing an indication of the determined ML model to a second node operating in the computer system.

2. The method according to claim 1, further comprising at least one of:
obtaining the first radio coverage data, the first radio coverage data comprising:
one or more floor plans comprising a respective distribution of a respective set of one or more first radio antennas, and a respective set of radio performance data collected from a respective plurality of devices operating in respective spaces defined by the one or more floor plans, wherein each of the one or more floor plans (121) comprises a respective distribution of obstacles; and
extracting, from the obtained first radio coverage data, and per floor plan of the one or more floor plans:
first information indicating the respective distribution of the obstacles, the first information comprising at least one of: a) a number of the obstacles and b) a distribution of the obstacles;
second information indicating a respective location of the respective set of one or more first radio antennas; and
third information indicating a respective contour of the one or more floor plans; and
wherein the extracting is based on image processing and wherein the determining of the ML model is based on the extracted first information, second information and third information.

3. The method according to claim 2, further comprising:
determining, per floor plan of the one or more floor plans, and based on the extracted first information, second information and third information, fourth information indicating a respective set of one or more zones, wherein each zone corresponds to a respective density level of the obstacles, and wherein the determining of the ML model is based on the determined fourth information.

4. The method according to claim 3, wherein the determined ML model is to estimate the number of the respective one or more radio antennas necessary to provide radio coverage to the space, per zone.

5. The method according to claim 3, wherein the determining of the fourth information comprises:
determining, for every pixel in one or more images comprised in the first radio coverage data, a first respective number of obstacles in all directions given a respective radial profile;
determining, for every pixel in one or more images comprised in the first radio coverage data based on the determined first respective number of obstacles, a respective density of obstacles; and
determining the respective set of one or more zones as a respective number of zones per floor map based on the determined respective density of obstacles per pixel.

6. The method according to claim 1, wherein the determining of the ML model comprises a training phase, during which the ML is trained, and an inference phase, wherein the inference phase is reached once a desired accuracy level of the ML model is reached.

7. The method according to claim 6, further comprising:
obtaining, once the ML model has been determined to have the desired accuracy level, second radio coverage data to be used as input for the determined ML model, the second radio coverage data comprising:
fifth information indicating a target space where radio coverage is to be provided by the number of one or more radio antennas to be estimated by the ML model;
sixth information indicating one or more second zones in the target space; and
seventh information indicating a type of second radio antennas to be used to provide the coverage in the target space; and
inferencing, in the absence of a floor plan corresponding to the target space, and using the determined ML model, the number of one or more radio antennas necessary to provide radio coverage to the target space, and wherein the provided indication indicates the inferenced number of the one or more radio antennas necessary to provide radio coverage to the target space.

8. The method according to claim 7, wherein the method further comprises:
determining, based on the inferenced number of the one or more radio antennas necessary to provide radio coverage to the target space, a set of materials necessary to provide the radio coverage to the target space with the inferenced number of the one or more radio antennas; and
wherein the provided indication further indicates the determined set of materials.

9. The method according to claim 7, wherein the provided indication is one of: a) a first indication indicating the determined ML model and b) a second indication indicating the number of one or more radio antennas.

10. The method according to claim 1, wherein the determining of the ML model is based on an optimization of pathloss in the space.

11. A computer-implemented method, performed by a second node, the method being for planning radio coverage in a space, the second node operating in a computer system, the method comprising:
obtaining, from a first node operating in the computer system, an indication of a determined machine learning, ML, model, the ML model being to estimate a number of one or more radio antennas necessary to provide radio coverage to a space, the estimate to be performed in the absence of a floor plan corresponding to the space;
inferencing, in the absence of a floor plan corresponding to a target space, and using the determined ML model, the number of one or more radio antennas necessary to provide radio coverage to the target space; and
outputting a second indication based on a result of the inferencing, the second indication indicating the inferenced number of the one or more radio antennas necessary to provide radio coverage to the target space.

12. The method according to claim 11, further comprising:
obtaining second radio coverage data comprising:
fifth information indicating the target space where radio coverage is to be provided by the number of one or more radio antennas to be estimated by the ML model;
sixth information indicating one or more second zones in the target space; and
seventh information indicating a type of second radio antennas to be used to provide the coverage in the target space; and
wherein the inferencing is based on the obtained fifth information, sixth information and seventh information.

13. The method according to claim 11, further comprising:
determining, based on the inferenced number of the one or more radio antennas necessary to provide radio coverage to the target space, a set of materials necessary to provide the radio coverage to the target space with the inferenced number of the one or more radio antennas; and
wherein the output second indication further indicates the determined set of materials.

14. The method according to claim 11, wherein the determined ML model is to estimate the number of the respective one or more radio antennas necessary to provide radio coverage to the space, per zone.

15. A first node, for planning radio coverage in a space, the first node being configured to operate in a computer system, the first node being further configured to:
determine, using machine learning, ML, and first radio coverage data from one or more first communications networks, an ML model to estimate a number of one or more radio antennas necessary to provide radio coverage to the space, the estimate being configured to be performed in the absence of a floor plan corresponding to the space; and
provide an indication of the ML model configured to be determined to a second node configured to operate in the computer system.

16. The first node according to claim 15, being further configured to at least one of:
obtain the first radio coverage data, the first radio coverage data being configured to comprise:
one or more floor plans configured to comprise a respective distribution of a respective set of one or more first radio antennas, and a respective set of radio performance data configured to be collected from a respective plurality of devices configured to operate in respective spaces configured to be defined by the one or more floor plans, wherein each of the one or more floor plans is configured to comprise a respective distribution of obstacles; and
extract, from the first radio coverage data configured to be obtained, and per floor plan of the one or more floor plans:
first information configured to indicate the respective distribution of the obstacles, the first information being configured to comprise at least one of: a) a number of the obstacles and b) a distribution of the obstacles;
second information configured to indicate a respective location of the respective set of one or more first radio antennas; and
third information configured to indicate a respective contour of the one or more floor plans; and
wherein the extracting is configured to be based on image processing and wherein the determining of the ML model is configured to be based on the first information, the second information and the third information configured to be extracted.

17. The first node according to claim 16, further configured to:
determine, per floor plan of the one or more floor plans, and based on the first information, second information and third information configured to be extracted, fourth information configured to indicate a respective set of one or more zones, wherein each zone is configured to correspond to a respective density level of the obstacles, and wherein the determining of the ML model is configured to be based on the fourth information configured to be determined, wherein the determining of the fourth information comprises:
determining, for every pixel in one or more images configured to be comprised in the first radio coverage data, a first respective number of obstacles in all directions given a respective radial profile;
determining, for every pixel in one or more images configured to be comprised in the first radio coverage data based on the first respective number of obstacles configured to be determined, a respective density of obstacles and
determining the respective set of one or more zones as a respective number of zones per floor map based on the respective density of obstacles configured to be determined per pixel.

18. The first node according to claim 17, wherein the determined ML model is configured the estimate the number of the respective one or more radio antennas necessary to provide radio coverage to the space, per zone.

19. (canceled)

20. The first node according to claim 15, wherein the determining of the ML model is configured to comprise a training phase, during which the ML is configured to be trained, and an inference phase, wherein the inference phase is configured to be reached once a desired accuracy level of the ML model is reached.

21.-24. (canceled)

25. A second node, for planning radio coverage in a space, the second node being configured to operate in a computer system, the second node being further configured to:
obtain, from a first node configured to operate in the computer system, an indication of a determined machine learning, ML, model, the ML model being configured to estimate a number of one or more radio antennas necessary to provide radio coverage to a space, the estimate being configured to be performed in the absence of a floor plan corresponding to the space;
infer, in the absence of a floor plan corresponding to a target space, and using the determined ML model, the number of one or more radio antennas necessary to provide radio coverage to the target space; and
output a second indication based on a result of the inferencing, the second indication being configured to indicate the number configured to be inferenced of the one or more radio antennas necessary to provide radio coverage to the target space.

26.-32. (canceled)
